(19) United States
(12) Patent Application Publication
(10) Pub. No.: US 2019/0348839 A1
(43) Pub. Date: Nov. 14, 2019

(54) A SYSTEM AND METHOD FOR CONTROLLING DEVICES IN A POWER DISTRIBUTION NETWORK

(71) Applicant: Upside Energy Ltd., Manchester (GB)

(72) Inventor: Graham Oakes, Manchester (GB)

(21) Appl. No.: 16/310,316

(22) PCT Filed: Jun. 15, 2017
(86) PCT No.: PCT/GB2017/051748

§ 371 Date: Dec. 14, 2018

(30) Foreign Application Priority Data
Jun. 17, 2016 (GB) 1610634.6

(51) Int. Cl. H02J 3/32; H02J 13/00; H02J 9/06; H02J 7/00; H02J 3/38

(52) U.S. Cl. CPC H02J 3/32; H02J 13/0006; H02J 3/386; H02J 7/0068; H02J 3/383; H02J 9/061

(57) ABSTRACT

A method of controlling a plurality of power units (106a to 106n) in a power distribution network (PDN) is provided. The method comprising: a) receiving a first parameter indicative of the inertia of the PDN; b) determining, based on at least the first parameter, a proportion of the power units to allocate to a reserve and/or charging state; and c) instructing, based on the determination, one or more of the plurality of power units to enter a reserve and/or charging mode in order that the determined proportion of the power units is allocated to the reserve and/or charging state.

### BACKGROUND TO THE INVENTION

Power distribution networks (PDNs), such as the United Kingdom's National Grid, connect power generation systems to consumers. A typical modern PDN will be supplied with electrical power from a wide variety of power generation techniques, from many different power stations spread across large geographical areas. At any one time, a PDN may be connected to, for example, coal-fired power stations, gas-fired power stations, oil-fired power stations, nuclear power stations, wind turbines and solar farms, spread over many hundreds of miles of terrain.

The power generation techniques used in modern power stations can be divided into two groups: 1) inertia-contributing power technologies, and 2) inertia-less power technologies. Inertia is the resistance of an object to a change in its state of motion. Inertia-contributing power technologies generate electricity by rotationally driving large magnetic masses within coils of wire. The resistance of the rotating masses to changes in their rotational speed is thus a form of inertia. Typical examples of inertia-contributing power stations include coal, gas, oil and nuclear stations. These inertia-contributing power stations create the energy needed to turn large turbines which, through their rotation, generate electricity. Inertia-less power technologies directly convert incident energy to electricity without the need for an intermediate rotational generator. A typical example of an inertia-less power station is a solar farm, which uses photovoltaic cells to convert sunlight into electricity.

As governments and consumers strive to lower their carbon dioxide emissions, inertia-less power generation systems are contributing a higher proportion of the power supplied to PDNs. Whilst reducing the carbon emissions of a PDN has significant environmental benefits, it can also seriously affect the stability of the PDN. The inertia of the inertia-contributing power stations smooths and delays any changes to the grid frequency. As the inertia across a PDN reduces, the PDN has less in-built resistance to changes in grid frequency.

The operators of PDNs strive to continuously balance the frequency of the grid by balancing the electricity supplied to the PDN by the connected power stations and the electricity drawn from the grid by the consumers. If the electricity drawn from the PDN exceeds the electricity supplied to the PDN, the rotational frequency of the generation equipment reduces, which in turn lowers the grid frequency. If this drop in grid frequency is not quickly corrected, generation equipment and connected consumer devices may be damaged or trip-out causing wide-spread blackouts. Similarly, if the electricity supplied to the PDN exceeds the amount drawn from the PDN, the rotational frequency of the generation equipment will increase, which will raise the grid frequency with equally damaging effects.

Demand for power across a network is not constant and is influenced by many different factors. The factors include the time of day, the time of year, the weather and even the timing of national sporting events. Whilst the future demand on a power network can (to a certain extent) be predicted by analysing real time data services such as the Balancing Mechanism Reporting System (BMRS), weather forecasts and predictions from national bodies, unexpected surges in demand are a very common occurrence.

To cope with fluctuations in the demand for electricity, PDNs require large amounts of reserve generation capacity which can quickly supply electricity to the PDN, counteracting any change in the grid frequency. Due to the difference in power generation technology response times and longevity, many different power generation technologies must be kept ready. For example, a hydro-electric dam may be able to start generating power within minutes, but the dam can produce power for only a finite time. Whereas, an oil-fired power station may take 20 minutes to start but can generate power indefinitely.

Having large amounts of power generation capacity sitting idle whilst waiting for peaks in demand is both expensive and inefficient. Moreover, as the inertia of the PDN is reduced, more and more reserve power generation capacity is required. In particular, increasing amounts of fast-reacting power generation capacity is required to safely cope with fluctuations in grid frequency, as there is less inertia in the PDN resisting change to grid frequency. Power generation systems capable of providing fast-reacting power generation, such as diesel-electric generators and hydroelectric power plants, are some of the most expensive forms of power generation to build, maintain and operate.

Therefore, there exists a need for an improved method of coping with fluctuations in the demand for electricity.

### SUMMARY OF THE INVENTION

In a first aspect, the present invention provides, a method of controlling a plurality of power units in a power distribution network (PDN), comprising: receiving a first parameter indicative of the inertia of the PDN; determining, based on at least the first parameter, a proportion of the power units to allocate to a reserve state; instructing, based on the determination, one or more of the plurality of power units to enter a reserve mode in order that the determined proportion of the power units is allocated to the reserve state.

In a second aspect, the present invention provides, a power distribution network (PDN), comprising: a plurality of power units; and a controller; wherein the controller is arranged to: receive a first parameter indicative of the inertia of the PDN; determine, based on at least the first parameter, a proportion of the power units to allocate to a reserve state; and instruct, based on the determination, one or more of the plurality of power units to enter a reserve mode in order that the determined proportion of the power units is allocated to the reserve state.

In a third aspect, the present invention provides, a method of controlling a plurality of power units in a power distribution network (PDN), comprising: receiving a first request to supply power to, or draw power from, the PDN; receiving a first parameter indicative of the inertia of the PDN; determining, based on the first request and the first parameter, a proportion of the power units that are in a reserve state to instruct to provide power to, or draw power from, the PDN; instructing, based on the determination, one or more of the plurality of power units in the reserve state to supply or draw power from the PDN in order that the determined proportion of the power units to instruct are instructed.

In a fourth aspect, the present invention provides, a power distribution network (PDN), comprising: a plurality of power units; and a controller; wherein the controller is arranged to: receive a first request to supply power to, or draw power from, the PDN; receive a first parameter indicative of the inertia of the PDN; determine, based on the first request and the first parameter, a proportion of the power units that are in the reserve state to instruct to provide power to, or draw power from, the PDN; instruct, based on the determination, one or more of the plurality of power units in the reserve state to supply or draw power from the PDN in order that the determined proportion of the power units to instruct are instructed.

In a fifth aspect, the present invention provides, a computer program comprising code which, when run on a computer, would cause the computer to perform either of the methods described above.

In a sixth aspect, the present invention provides, a computer readable medium having code stored thereon which, when run on a computer, causes the computer to perform either of the methods described above.

Further features of the invention are defined in the appended dependent claims.

### BRIEF DESCRIPTION OF THE DRAWINGS

By way of example only, the present invention will now be described with reference to the drawings, in which:

FIG. 1 shows a power distribution network in accordance with a first embodiment of the invention;

FIG. 2 is a flow-chart showing a method of operation of the power distribution network in accordance with the first embodiment of the invention;

FIG. 3 is a graph showing the proportion of devices in each power state during period of low inertia of the power distribution network;

FIG. 4 is a graph showing the proportion of devices in each power state during period of high inertia of the power distribution network;

FIG. 5 is a graph showing the changing proportion of power units in a reserve state relative to the change in inertia of the power distribution network;

FIG. 6 is a flow-chart showing a method of operation of the power distribution network in accordance with a second embodiment of the invention;

FIG. 7 is a graph showing the response of the power distribution network to a frequency response request in accordance with the second embodiment of the invention;

FIG. 8 is a graph showing the response of the power distribution network to a frequency response request in accordance with the second embodiment of the invention;

FIG. 9 is a graph showing the response of the power distribution network to a frequency response request in accordance with the second embodiment of the invention;

FIG. 10 is a graph showing the response of the power distribution network to a frequency response request in accordance with the second embodiment of the invention;

FIG. 11 is a graph showing the response of the power distribution network to a frequency response request in accordance with the second embodiment of the invention.

### DETAILED DESCRIPTION OF PREFERRED EMBODIMENTS

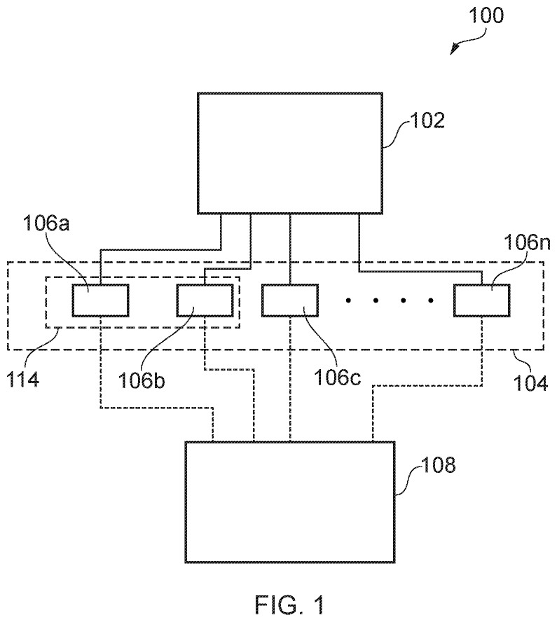

A first embodiment of the present invention will now be described with reference to FIG. 1. FIG. 1 shows a power distribution network 100. The power distribution network 100 includes a power grid 102. The power grid 102 is an electricity distribution grid, such as the UK's National Grid.

The power distribution network 100 also includes a fleet 104 of uninterruptable power supply (UPS)-based devices 106a, 106b, 106c, 106n. These devices are capable of drawing power from and/or supplying power to the power grid 102. For ease of understanding, only four devices are shown in FIG. 1. In practice, there may be thousands, if not millions of devices forming part of the power distribution network 100. The precise number is not relevant to the understanding of this embodiment. The amount of power drawn from the power grid 102 by devices 106a, 106b, 106c, 106n can be controlled. In addition to this, or in some cases as an alternative, the amount of power supplied to the power grid 102 by devices 106a, 106b, 106c, 106n can be controlled. As such, the power distribution network 100 may be controlled to increase or decrease the demand on the power grid 102, or to increase or decrease the amount of power supplied to the power grid 102.

The UPS-based devices 106a, 106b, 106c, 106n will be in at least one of four states. When the UPS-based devices 106a, 106b, 106c, 106n are powering a local load, the device will be in a DISCHARGING state. In other words, the UPS will be reducing the power demand on the grid 102 by taking load off the grid 102. The local load could be any device, or group of devices capable of being powered by the UPS. Typically a UPS will be used to power at least part of a home, office or factory.

When the UPS-based devices 106a, 106b, 106c, 106n are drawing power from the grid 102, for example to power a local load and/or to recharge local batteries, the devices will be in a CHARGING state. In other words, the UPS will be increasing the power demand on the grid 102.

When the UPS-based devices 106a, 106b, 106c, 106n are neither drawing power from the grid nor supplying power to the local load, but are available to perform either of these actions, the devices will be in a RESERVE state. Furthermore, a UPS-based device may also be considered to be in a RESERVE state if it is currently in a DISCHARGING state but able to increase the power supplied to the local load. Alternatively, the devices may be in a RESERVE state if the devices are in a CHARGING state but able to increase the power drawn from the grid 102, such as by powering the local load from the grid whilst also recharging the UPS-device's batteries from the grid. If the UPS-based device 100 is unavailable to the power distribution network 100, for example for maintenance, it will be in a WITHDRAWN state.

The power distribution network 100 also includes a controller 108. The controller 108 is arranged to send and receive data from all of the devices, 106a, 106b, 106c and 106n. In particular, the controller 108 is arranged to receive information indicative of the current state of the devices 106a, 106b, 106c, 106n and, when necessary, to send instruction messages to tell the devices to change state. To achieve this, the devices 106a, 106b, 106c and 106n include a communications module (not shown) enabling two-way communication with the controller 108. The communications modules may use any suitable communications technology, such as a modem or a cellular phone.

In FIG. 1, UPS-based devices 106a, 106b, 106c, 106n are shown as directly linked to the controller 108. In practice, the devices 106a, 106b, 106c, 106n may be linked to the controller 108 by an intermediate network (not shown), such as the Internet. In this manner, each device 106a, 106b, 106c, 106n may exchange information with the controller 108 through the intermediate network, without the need for a direct connection.

The controller 108 may also use information received from the devices 106a, 106b, 106c and 106n to construct a statistical overview of all devices in the fleet 104. These statistical views include information on the overall fleet 104 state. In particular, this may include:
The number of devices in the fleet;
The total rated power and energy capacity of these devices;
The total current available power and energy capacity of these devices;
The number of devices in each of the four device states—CHARGING, DISCHARGING, RESERVE and WITHDRAWN;
The rated power and energy capacity of devices in each of the four device states; and
The current power and energy capacity of the devices in each of the four device states.

As discussed previously, the controller 108 may control each of the UPS-based devices 106a, 106b, 106c, 106n via their respective communication modules (not shown). The controller 108 can instruct the devices 106a, 106b, 106c and 106n to enter a CHARGING state, a DISCHARGING state and/or a RESERVE state by sending a control message to each device. In this manner, the controller can change the states of the devices 106a, 106b, 106c and 106n.

The controller 108 is also arranged to receive parameters which are indicative of the inertia of the power grid 102. The parameters may include any information from which the inertia of the grid 102, or change in inertia of the grid 102, may be ascertained either directly or indirectly. This data may be, for example, be one or more of the following:
a direct measurement of the inertia of the grid 102;
a measure of the frequency deadband to be applied to frequency regulation services provided to the grid;
a measure of the proportion of inertia contributing power generation systems supplying power to the grid;
a measure of the frequency of the grid;
a measure of the rate of change of the frequency of the grid;
a measure of the carbon intensity of the grid; and
an indication of the future scheduling of one or more of the power generation systems supplying power to the grid.

In the present example, measurements of grid inertia are used to manage the proportion of devices needed to be held in reserve to service requests to provide power to, or draw power from the grid 102. When the inertia of the grid 102 is relatively low, indicating a reduced level of spinning reserve, the grid frequency will more rapidly change following an unexpected change in the demand for power. In these circumstances, a higher level of response will be required to counteract the potential for a rapid change in grid frequency. As such, more of the UPS-based devices 106a, 106b, 106c, 106n will need to be held in a RESERVE state to be able to quickly provide power to the grid 102.

Similarly, when the inertia of the grid is relatively high, indicating a high level of spinning reserve, the frequency of the grid will change more slowly when demand is increased. Hence, during periods of high grid inertia, a lower level of response will be required to counteract the change in grid frequency. As such, fewer of the UPS-based devices 106a, 106b, 106n need to be held in a RESERVE state.

Because the fleet of UPS-based devices may contain many thousands of devices, the level of reserve power may be controlled to a finer degree than would be the case with a small number of larger devices.

In a similar manner, the measurements of grid inertia may also be used to manage the proportion of devices that are placed into a CHARGING state, allowing depleted batteries to be recharged so that they may later be placed into a RESERVE state ready to supply power to the grid. For example, when the inertia of the grid is relatively high and hence the need for devices to be held in reserve is low, it may be an opportune time to recharge batteries. Therefore, more of the UPS-based devices 106a, 106b, 106c, 106n will be placed into a CHARGING state.

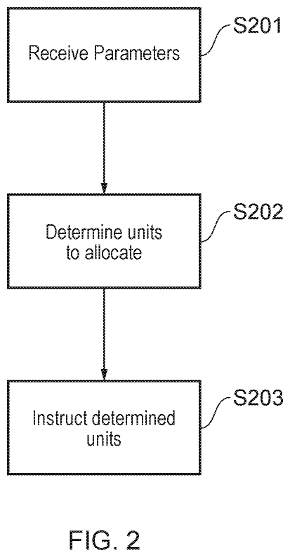

The operation of the power distribution network 100 will now be described in more detail, with reference to FIG. 2.

FIG. 2 is a flow-chart showing the operation of the power distribution network 100. The controller 108 receives (S201) one or more parameters indicative of the inertia of the grid 102. The controller 108 determines (S202), based on the received parameter(s), a proportion of the available devices 106a, 106b, 106c, 106n to allocate to a RESERVE state and/or a CHARGING state. When the received parameters indicate a period of relatively low inertia in the grid, a higher proportion of the available UPS-based devices 106a, 106b, 106c, 106n are allocated to a RESERVE state. To ensure adequate numbers of UPS-based devices 106a, 106b, 106c, 106n can be allocated the RESERVE state to achieve the proportion of devices needed in the RESERVE state, devices currently in the CHARGING state may be allocated to a RESERVE state. Conversely, when the received parameters indicate a period of relatively high inertia in the grid, a lower proportion of the available UPS-based devices 106a, 106b, 106c, 106n are allocated to a RESERVE state, and a higher proportion of devices may be allocated to a CHARGING state.

Once the controller has determined (S202) the proportion of available devices 106a, 106b, 106c and 106n to be allocated to RESERVE and/or CHARGING states, the controller sends (S203) control messages to the required devices such that the proportion of devices allocated to the respective states is met. Depending on the determined proportion, one or more of the devices 106a, 106b, 106c and 106n may need to be instructed to enter a RESERVE state or a CHARGING state. Alternatively, fewer devices than are already in a RESERVE state may be needed in reserve. In this case, some devices may be instructed to enter a DISCHARGING, CHARGING, or WITHDRAWN state to reduce the proportion of devices held in the RESERVE state. In this manner, the controller 108 can optimise the number of devices 106a, 106b, 106c and 106n assigned to the RESERVE and CHARGING states as the inertia of the grid fluctuates over time.

In the present example, determination of the proportion of the devices 106a, 106b, 106c and 106n is based upon one or more received parameters indicative of inertia. To further refine the determination (S202), the controller 108 may base the determination on further parameters, such as one or more parameters indicative of the power the grid requires in reserve at any given level of inertia. For example, the grid may require 50 MW of reserve if the inertia of the grid is predicted to be the same as the average across the previous 24 hours (i.e. the “normal inertia”). Alternatively, the grid may require 100 MW of reserve for situations where the grid has zero inherent inertia, or 40 MW of reserve for situations where the grid has higher than normal inertia.

Moreover, the controller 108 may also, or as an alternative, use any of the statistical data it holds about the fleet 104 to further refine the determination (S202) of the proportion of devices to be allocated to a RESERVE state.

In the above example, determination (S202) of the proportion of devices 106a, 106b, 106c and 106n to be allocated to a RESERVE or CHARGING state is based on, at least, an indication of the present inertia of the grid 102. However, the controller may also analyse commonly available parameters related to the grid 102, to gain an indication of the likely inertia of the grid in the future. In this manner it is possible to pro-actively manage the proportion of devices 106a, 106b, 106c and 106n to make better use of available resources.

Consequently, the controller 108 may also be arranged to receive and store parameters which are indicative of the future inertia of the grid 102. The parameters may include any information from which the future inertia of the grid 102, or the relative change in the future inertia of the grid 102, may be ascertained either directly or indirectly. This data may be, for example, the scheduling of an alteration to the frequency deadband to be applied to frequency regulation services provided to the grid 102, the scheduling of the power generation systems supplying power to the grid or a measure of the predicted carbon intensity of the grid.

A variety of methods of predicting the future inertia of the grid 102 may be used. For example, the controller may analyse the future scheduling of connected inertia-contributing power generation systems, analyse the predicted carbon intensity of the grid, analyse the time-based trends in the inertia of the grid and analyse the scheduling of events likely to effect the demand for power.

When indications of the future inertia of the grid 102 are available, the controller 108 may further refine the determination (S202) of the proportion of devices to allocate to a RESERVE state. An example decision matrix that may be applied by the controller 108 to make this determination (S202) is shown below:

| | | Current Inertia | |
|---|---|---|---|
| | | Low | High |
| Future Inertia | High | High Proportion of Devices Allocated | Low Proportion of Devices Allocated |
| | | to RESERVE State | to RESERVE State |
| | | Low Proportion of Devices Allocated | Moderate Proportion of Devices |
| | | to CHARGING State, as devices can | Allocated to CHARGING State, |
| | | be recharged later when inertia is | sufficient to maintain reserve levels |
| | | higher | For example: |
| | | For example: | 25% of devices in a RESERVE state |
| | | 40% of devices in a RESERVE state | 35% of devices in a CHARGING state |
| | | 20% of devices in a CHARGING state | 40% of devices in a DISCHARGING or |
| | | 40% of devices in a DISCHARGING or | WITHDRAWN state |
| | | WITHDRAWN state | |
| | Low | High Proportion of Devices Allocated | Low Proportion of Devices Allocated |
| | | to RESERVE State | to RESERVE State |
| | | Moderate Proportion of Devices | High Proportion of Devices Allocated |
| | | Allocated to CHARGING State, | to CHARGING State, to ensure |
| | | sufficient to maintain reserve levels | sufficient capacity for when inertia is |
| | | For example: | low in the future |
| | | 40% of devices in a RESERVE state | For example: |
| | | 30% of devices in a CHARGING state | 30% of devices in a RESERVE state |
| | | 30% of devices in a DISCHARGING or | 40% of devices in a CHARGING state |
| | | WITHDRAWN state | 30% of devices in a DISCHARGING or |
| | | | WITHDRAWN state |

In summary, the controller 108 may increase the proportion of the devices 106a, 106b, 106c and 106n allocated to the RESERVE state in response to receiving an indication of a decrease in the inertia of the grid 102 in the future. Similarly, the controller 108 may decrease the proportion of the devices 106a, 106b, 106c and 106n allocated to the RESERVE state in response to receiving an indication of an increase in the inertia of the grid 102 in the future.

In a similar manner, the controller 108 may adjust the proportion of devices allocated to the CHARGING state to make best use of time periods when reserve services are less likely to be needed, i.e. periods of high grid inertia. However, a moderate proportion of the devices 106a, 106b, 106c and 106n may need to be allocated to a CHARGING state, as shown in the above matrix, to ensure sufficient numbers of devices have adequate charge to be useful in a RESERVE state at later times. The controller 108 may also consider other factors when deciding the proportion of devices to allocate to a CHARGING state, such as the carbon intensity of the grid, so that it can schedule charging for times of low carbon intensity, thereby reducing the environmental impact of charging.

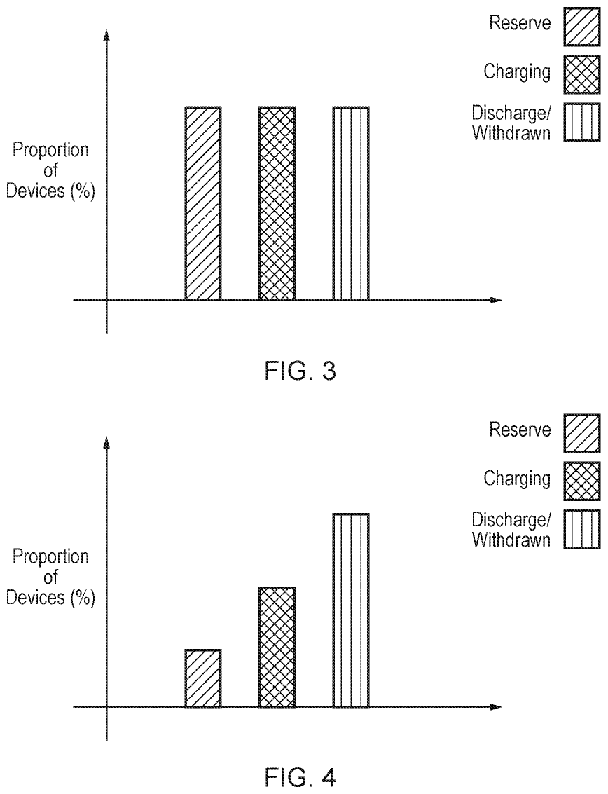

FIG. 3 is a graph showing the proportion of devices 106a, 106b, 106c and 106n allocated to either a RESERVE state, a CHARGING state, or a WITHDRAWN/DISCHARGING state during a period of relatively low inertia of the grid, with a presumption that the inertia of the grid will remain relatively low for the near future. In accordance with the above described decision matrix, a high proportion of the devices (in this example 40% of the devices) are held in a RESERVE state. A moderate proportion (30%) of the devices are in a CHARGING state and the remaining 30% of devices are in a WITHDRAWN/DISCHARGING state.

FIG. 4 is a graph showing the proportion of devices 106a, 106b, 106c and 106n allocated to either a RESERVE state, a CHARGING state, or a WITHDRAWN/DISCHARGING state during a period of relatively high inertia of the grid, with a presumption that the inertia of the grid will remain relatively high for the near future.. In accordance with the above described decision matrix, a lower proportion of the devices (in this example 25% of the devices) are now held in a RESERVE state. A moderate proportion (35%) of the devices are in a CHARGING state and the remaining 40% of the devices are in a DISCHARGING/WITHDRAWN state.

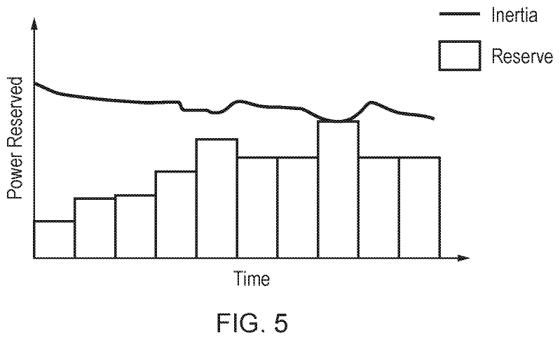

An advantage of the presently described invention is that the proportion of devices 106a, 106b, 106c and 106n held in the RESERVE and CHARGING states can be continuously adjusted as the inertia of the grid 102 fluctuates. FIG. 5 is a graph showing how the proportion of devices held in the RESERVE state is adjusted as the current inertia and/or predicted future inertia of the PDN changes in time.

In one example, relative inertia is determined as percentage change from a predetermined, normal level. The operator of each fleet of devices may agree a particular power level it must keep in reserve for a normal level of inertia. For example, a UPS-based fleet having 10,000 devices may provide 50 MW of standby power for normal inertia. This represents 50% of the devices. As inertia shifts away from normal, the amount of power that is kept in reserve, and hence the percentage of devices kept in reserve, changes accordingly. The following table demonstrates one example:

| Relative inertia | Reserve power | Proportion of devices |
|---|---|---|
| +30% | 44 MW | 44% |
| +20% | 46 MW | 46% |
| +10% | 48 MW | 48% |
| Normal | 50 MW | 50% |
| −10% | 52 MW | 52% |
| −20% | 54 MW | 54% |
| −30% | 56 MW | 56% |

An advantage of the above described embodiment is that only those devices which are required be held in a RESERVE state at any given time are held in a RESERVE state. In other words, the system can dynamically optimise the number of devices held in a RESERVE state, freeing up as many devices as possible to perform other functions. This in turn reduces the overall reserve power generation capacity the PDN must keep in reserve thereby reducing greenhouse gas emissions and costs associated with maintaining the necessary reserve required to ensure the frequency stability of the grid.

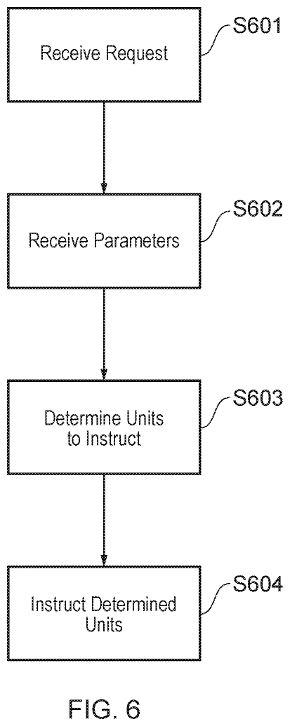

In a second embodiment of the invention, a further method of using the power distribution network 100 is described with reference to FIGS. 6.

FIG. 6 is a flow-chart showing the operation of the power distribution network 100. The controller 108 receives (S601) a request to supply power to, or draw power from, the grid 102. The request may be a frequency response request, such as a Demand Response Event Notice (DREN), issued by the operator of the power grid 102. DRENs are requests from the grid for systems, such as the one described here, to reduce or increase demand on the grid. Such requests typically include an amount of power to be supplied to, or drawn from, the grid 102 and/or a response time within which the request must be fulfilled.

The controller 108 also receives (S602) one or more parameters indicative of the inertia of the grid 102. The controller 108 determines (S603), based on the received parameter(s) and the received request, a proportion of the devices in a RESERVE state to instruct to provide power to, or draw power from, the grid 102. When the received parameters indicate a period of relatively low inertia in the grid 102, a higher proportion of the UPS-based devices 106a, 106b, 106c, 106n are to be instructed to provide power to, or draw power from, the grid 102. Conversely, when the received parameters indicate a period of relatively high inertia in the grid 102, a lower proportion of the UPS-based devices are to be instructed to provide power to, or draw power from, the grid 102.

In a similar manner, the controller 108 may determine (S603), based on at least the received parameter(s) and the received request, a proportion of devices which should be placed into a CHARGING state in order to maintain sufficient capacity of charged devices to meet future reserve requirements. For example, when the received parameter(s) indicate a period of relatively high inertia in the grid, a higher proportion of devices may be instructed to go into a CHARGING state, thus ensuring sufficient devices are charged for future use as reserve devices.

The received (S602) parameters may include any information from which the inertia of the grid 102 may be ascertained either directly or indirectly. This data may be, for example, a measure of the inertia of the grid 102, a measure of the frequency deadband to be applied to the provision of frequency regulation services for the grid 102 or a measure of the proportion of inertia contributing power generation systems supplying power to the grid.

Once the controller has determined (S603) the proportion of devices to be controlled to provide power to, or draw power from, the grid 102, the controller sends (S604) control messages to the required devices such that the proportion of devices to control are instructed. The control messages sent to the devices include an instruction to either supply power to, or draw power from, the grid 102.

In the present example, the determination (S603) of the proportion of the devices in a RESERVE state to instruct is based upon one or more received parameters indicative of inertia. To further refine the determination (S603), the controller 108 may base the determination on further parameters, such as any of the statistical data it holds about the devices 106a, 106b, 106c and 106n and/or the fleet 104.

Moreover, to refine the determination (S603), the controller 108 may base the determination (S603) on further parameters, such as the frequency of the grid 102 and/or the rate of change of the frequency of the grid.

An advantage of the present system's ability to control a large number of devices is that devices can be instructed in such a manner as to shape the power response provided by the PDN 100 to the request to supply power to, or draw power from, the grid. As such, power does not have to be supplied instantaneously.

Therefore, the control messages sent (S604) to the required devices may further include a time at which to start drawing power from, or supplying power to the grid 102 and/or a time period for which to draw power from or supply power to the grid. By sending control messages which instruct different devices to supply or draw power starting at different times and/or for different lengths of time, the power response of the PDN can be shaped. In addition to this, or in some cases as an alternative, the control messages sent to the required devices may be sent at predetermined time intervals, which are arranged to further allow shaping of the power response of the PDN 100.

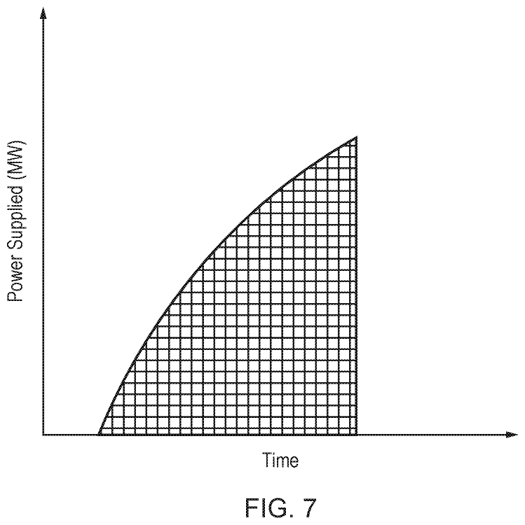

FIG. 7 is a graph showing a shaped power response for responding to a 10 MW frequency response request in accordance with the present invention. Each square on the graph represents a device, or group of devices, instructed to supply power to the grid. For larger frequency response requests, each box may represent hundreds or thousands of individual devices supplying power to the grid. At time 0, a frequency response request is received. After a time delay, the first devices are instructed to supply power to the grid 102, after a further time interval more devices are instructed to supply power to the grid 102. As time passes, more and more devices are instructed to supply power to the grid 102 resulting in a shaped power response to the request. The shaped power response shown in FIG. 7 is further described in numbers in the table below, based on the assumption that each group of devices supplying power to the grid supplies 10 KW of electricity for the duration they are instructed.

| Time | | Supplied Power |
|---|---|---|
| Point | Number of Groups of Devices Supplying Power | (MW) |
| 1 | 1 | 0.1 |
| 2 | 3 | 0.3 |
| 3 | 7 | 0.7 |
| 4 | 11 | 1.1 |
| 5 | 18 | 1.8 |
| 6 | 27 | 2.7 |
| 7 | 36 | 3.6 |
| 8 | 46 | 4.6 |
| 9 | 58 | 5.8 |
| 10 | 70 | 7 |
| 11 | 84 | 8.4 |
| 12 | 100 | 10 |

The above table assumes that each device instructed is able to supply a set amount of power for the entirety of the duration of the shaped power response. In reality, not all devices connected to the grid will be able to achieve this. To overcome this shortcoming, further devices will be instructed to supply power to the grid. Moreover, it may not be desirable for a device to be instructed to supply power for the entirety of the shaped response. Consequently, some devices supplying power to the grid may be instructed to reduce or stop supplying power to the grid; these devices being replaced by others of the devices held in a RESERVE state.

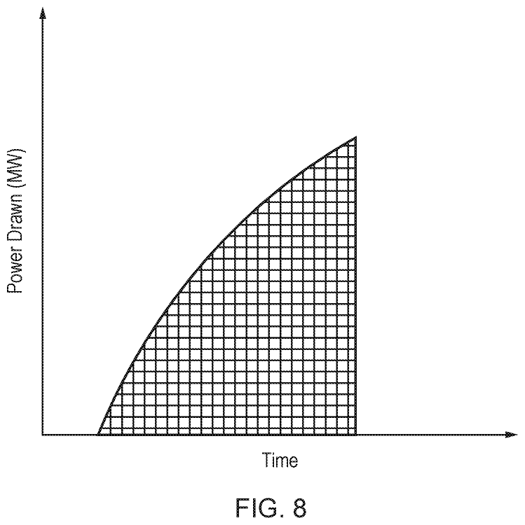

FIG. 8 is a graph showing a shaped power response for responding to a 10 MW frequency response request in accordance with the present invention. However, the frequency response request in this case is one to draw more power from the grid, due to an increase in grid frequency. Each square on the graph represents a device, or group of devices, instructed to draw power from the grid. For larger frequency response requests, each box may represent hundreds or thousands of individual devices drawing power from the grid. At time 0, a frequency response request is received. After a time delay, the first devices are instructed to draw power from the grid 102, after a further time interval more devices are instructed to draw power from the grid 102. As time passes, more and more devices are instructed to draw power from the grid 102 resulting in a shaped power response to the request. The shaped power response shown in FIG. 8 is further described in numbers in the table below, based on the assumption that each group of devices drawing power from the grid draws 10 KW of electricity for the duration they are instructed.

| Time | Number | |
|---|---|---|
| Point | of Groups of Devices Drawing Power | Drawn Power (MW) |
| 1 | 1 | 0.1 |
| 2 | 3 | 0.3 |
| 3 | 7 | 0.7 |
| 4 | 11 | 1.1 |
| 5 | 18 | 1.8 |
| 6 | 27 | 2.7 |
| 7 | 36 | 3.6 |
| 8 | 46 | 4.6 |
| 9 | 58 | 5.8 |
| 10 | 70 | 7 |
| 11 | 84 | 8.4 |
| 12 | 100 | 10 |

The above table assumes that each device instructed is able to draw a set amount of power for the entirety of the duration of the shaped power response, for example by charging their batteries. In reality, not all devices connected to the grid will be able to achieve this. To overcome this shortcoming, further devices will be instructed to draw power from the grid. Moreover, it may not be desirable for a device to be instructed to draw power for the entirety of the shaped response. Consequently, some devices drawing power from the grid may be instructed to reduce or stop drawing power from the grid; these devices being replaced by others of the devices held in a RESERVE state.

The control messages sent (S604) to the determined devices may instruct different proportions of devices to supply power to or draw power from the grid in dependence on the amount of frequency deviation from the nominal frequency of the grid (i.e. the deviation from 50 Hz in the UK's National Grid). In this way, the power response of the fleet of devices can be shaped in accordance with the amount of frequency deviation. For example, a larger and faster response may be used to correct large frequency deviations from the nominal frequency. Similarly, smaller and/or slower responses may be used when there is less deviation from the nominal frequency.

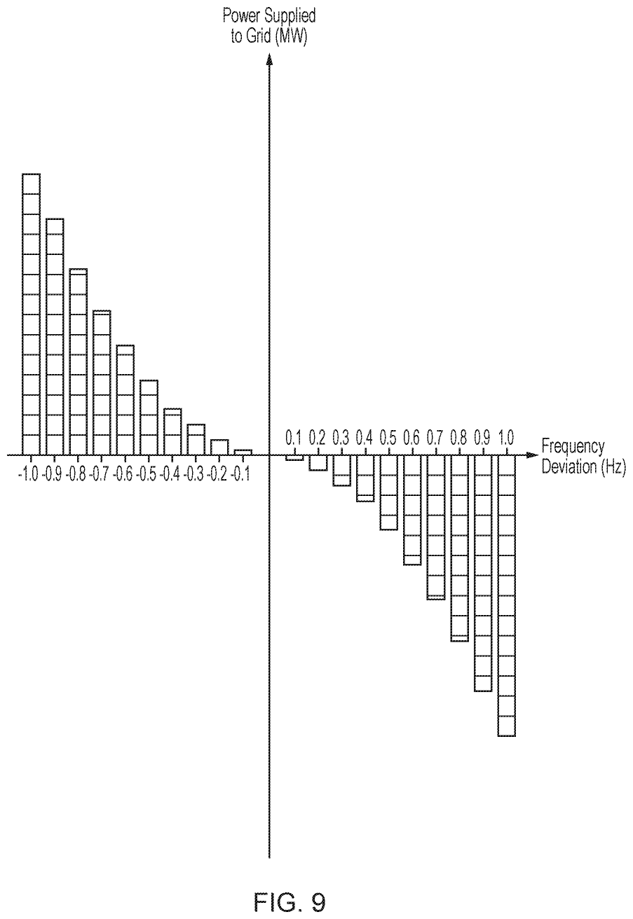

FIG. 9 is a graph showing a shaped power response for responding to different amounts of frequency deviation from the nominal frequency of the grid. Each square on the graph represents a device, or group of devices, instructed to supply power to, or draw power from, the grid. For larger frequency response requests, each box may represent hundreds or thousands of individual devices supplying power to the grid.

For small frequency deviations, a small number of devices are instructed to respond so at to correct the deviation. Whereas, for larger frequency deviations, a larger number of devices are instructed to respond so as to correct the deviation. The response curve may be highly non-linear, reflecting the fact that the grid is a non-linear system. Hence, simple linear response curves may not provide the optimum frequency regulation effect. In some circumstance, response curves approaching an exponential curve may be preferable.

The shaped power response shown in FIG. 9 is further exemplified in numbers below.

| Frequency | | Power |
|---|---|---|
| Deviation | Number of Groups of Devices Supplying or | Supplied to |
| (Hz) | Drawing Power | Grid (MW) |
| −1.0 | 70 | +7 |
| −0.9 | 58 | +5.8 |
| −0.8 | 46 | +4.6 |
| −0.7 | 36 | +3.6 |
| −0.6 | 27 | +2.7 |
| −0.5 | 18 | +1.8 |
| −0.4 | 11 | +1.1 |
| −0.3 | 7 | +0.7 |
| −0.2 | 3 | +0.3 |
| −0.1 | 1 | +0.1 |
| 0 | 0 | 0 |
| +0.1 | 1 | −0.1 |
| +0.2 | 3 | −0.3 |
| +0.3 | 7 | −0.7 |
| +0.4 | 11 | −1.1 |
| +0.5 | 18 | −1.8 |
| +0.6 | 27 | −2.7 |
| +0.7 | 36 | −3.6 |
| +0.8 | 46 | −4.6 |
| +0.9 | 58 | −5.8 |
| +1.0 | 70 | −7 |

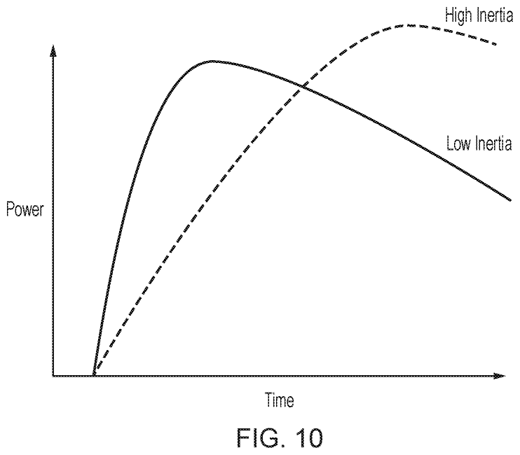

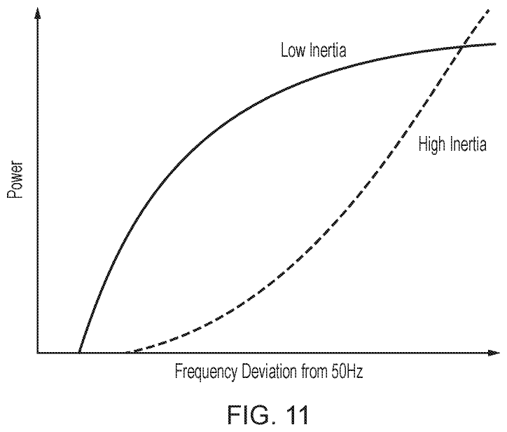

FIGS. 10 and 11 provide illustrative power response curves for both relatively high and relatively low inertia states of the grid. FIG. 10 shows exemplary power versus time curves for relatively high (dashed line) and relatively low (solid line) inertia states of the grid. FIG. 11 shows exemplary power versus frequency deviation from the nominal frequency (in this case 50 Hz) of the grid, for relatively high (dashed line) and relatively low (solid line) inertia states of the grid. These power response curves are described further in the following description.

In general, when the inertia of the grid 102 is low, we expect:
a smaller frequency deadband (frequency response services are thus provided for smaller frequency deviations);
the power supplied to, or drawn from the grid 102, will be shaped to peak early, as exemplified by the solid line curve in FIG. 10. I.e. a deeper power response will be provided more quickly, e.g. as enhanced or primary frequency response;
the power supplied to, or drawn from the grid, vs frequency will tend to be convex-up, as exemplified by the solid line curve in FIG. 11. I.e. we provide more response at higher frequencies/closer to the deadband.

Conversely when the inertia of the grid 102 is high, we expect:
a larger frequency deadband;
the power supplied to, or drawn from the grid 102, will be shaped to peak later, as exemplified by the dashed line curve in FIG. 10;
the power supplied to, or drawn from the grid, vs frequency will tend to be concave up, as exemplified by the dashed line curve in FIG. 11. I.e. more power capacity is held back for larger frequency deviations.

For reasons of efficiency, prior art frequency response services tend to use low numbers of high power generation systems, such as hydroelectric dams and diesel generators. However, these power generation systems tend not to be able to regulate the level of output power and function in either an “on” or “off” state. The present invention uses a high number of low power devices. As such, any response to a DREN may be far more precise, as these curves illustrate.

Due to advances in energy storage, there is an increasing pool of devices connected to the power generation network which are capable of providing significant amounts of power to the grid (102) very quickly. The presently described embodiments of the invention are particularly advantageous when applied to this increasing pool of connected devices. To this end, in the embodiments of the invention described above, the connected devices have been exemplified as uninterruptible power supplies (UPSs). Examples of other suitable devices include electric vehicles (EVs), and photovoltaic storage banks (PVs). The key advantages of these connected devices include being able to quickly supply power to the grid (102) when required and their ability to replenish their own capacity at times when there is an excess of supply, or in some cases, from local carbon-neutral power generators (such as linked solar panels).

However, to make a significant contribution to a large scale grid, the simultaneous use of thousands of devices is required. The presently described invention overcomes many of the difficulties inherent in efficiently using so many connected devices. By continuously optimising the number of devices held in a RESERVE state, the number of devices sitting idle whilst waiting for peaks in demand is reduced, increasing the efficiency of the system as a whole. Furthermore, the presently described invention enables more of these smart devices to provision local services, such as supplying power to local power networks and/or recharging discharged capacity, by removing the need for them to be held in a RESERVE state at all times. Furthermore, the present invention enables the recharging of these devices to be optimised so as to minimise the impact that charging has on the grid, to make best use of periods of low energy costs or to reduce the environmental impact of recharging, while ensuring that the necessary amount of reserve capacity is always available.

All of the devices noted above include battery storage. In terms of control, the devices are typically in reserve, charging or discharging the batteries. However, the power distribution network 100 may also control devices that use other energy storage technologies. For example, the power distribution network 100 could be connected to UPSs that store energy in flywheels, or to devices that include thermal energy stores. The network may also control devices that do not include batteries. For example, the network could be connected to heating units, such as heat pumps, or refrigerators. These units place demand on the power grid, when in use, and could be controlled in order to reduce the amount demand on the grid, in a similar way to UPSs, EVs and PVs.

Features of the present invention are defined in the appended claims. While particular combinations of features have been presented in the claims, it will be appreciated that other combinations, such as those provided above, may be used.

The above embodiments describe one way of implementing the present invention. It will be appreciated that modifications of the features of the above embodiments are possible within the scope of the independent claims.

1. A method of controlling a plurality of power units in a power distribution network (PDN), comprising:
a) receiving a first parameter indicative of an inertia of the PDN;
b) determining, based on the inertia of the PDN, a proportion of the power units to allocate to a reserve and/or charging state; and
c) instructing, based on the determination, one or more of the plurality of power units to enter a reserve and/or charging mode in order that the determined proportion of the power units is allocated to the reserve and/or charging state.

2. A method according to claim 1, wherein the proportion of the power units allocated to a reserve state is increased in response to a decrease in inertia.

3. A method according to claim 1, wherein the proportion of the power units allocated to a reserve state is decreased, and/or the proportion of the power units allocated to a charging state is increased, in response to an increase in inertia.

4. A method according to claim 1, wherein the step of determining the proportion of power units to allocate to a reserve and/or charging state is further based on a second parameter indicative of an amount of power the PDN requires in reserve, for a predetermined inertia.

5. A method according to claim 1, wherein said power units are batteries or other energy storage devices.

6. A method according to claim 5, wherein one or more batteries or energy storage devices form part of one or more uninterruptable power supplies.

7. A method according to claim 1, wherein depending on a level of charge of a power unit, a unit enters a reserve mode and charge mode simultaneously.

8. A method according to claim 1, wherein a power unit is arranged to charge from the PDN or from a local power source.

9. A method according to claim 8, wherein, when a power unit is arranged to charge from a local power source, the local power source is one or more of: a photovoltaic array, one or more wind turbines, a hydro electric generator, a biomass generator, a combined heat and power generator and a diesel generator.

10. A method according to claim 1, further comprising receiving a third parameter, indicative of predicted future inertia in the PDN; wherein the step of determining a proportion of the power units to allocate to a reserve and/or charging state is further based on the third parameter, wherein one or more of
the proportion of the power units allocated to a reserve state increased in response to a decrease in predicted future inertia,
the proportion of the power units allocated to the reserve state is decreased in response to an increase in the predicted future inertia,
the proportion of the power units allocated to a charging state is increased in response to the increase in the predicted future inertia.

11-12. (canceled)

13. A method according to claim 1,
wherein the first parameter comprises one or more of:
a measure of the inertia of the PDN,
a measure of a frequency deadband of the PDN, and
a measure of a proportion of inertia contributing power generation systems supplying power to the PDN,
the method further comprising one or more of:
(i) measuring the total power available from the plurality of power units, wherein said step of determining a proportion of power units to place in a reserve and/or charging state is further based on the total power available,
(ii) each power unit providing a status update including the power available from that unit, wherein the step of instructing one or more of the plurality of power units to enter a reserve and/or charging mode is further based on the power available in each unit.

14-15. (canceled)

16. A power distribution network (PDN), comprising:
a plurality of power units; and
a controller; wherein
the controller is arranged to:
a) receive a first parameter indicative of an inertia of the PDN;
b) determine, based on the inertia of the PDN, a proportion of the power units to allocate to a reserve and/or charging state; and
c) instruct, based on the determination, one or more of the plurality of power units to enter a reserve and/or charging mode in order that the determined proportion of the power units is allocated to the reserve and/or charging state.

17. A method of controlling a plurality of power units in a power distribution network (PDN), comprising:
a) receiving a first request to supply power to, or draw power from, the PDN;
b) receiving a first parameter indicative of an inertia of the PDN;
c) determining, based on the first request and the inertia of the PDN, a proportion of the power units that are in a reserve state to instruct to provide power to, or draw power from, the PDN;
d) instructing, based on the determination, one or more of the plurality of power units in the reserve state to supply or draw power from the PDN in order that the determined proportion of the power units to instruct are instructed.

18. A method according to claim 17, wherein the step of instructing one or more of the plurality of power units to supply or draw power from the PDN comprises: sending a control message to each of the one or more of the plurality of power units to be instructed,
wherein the control message sent to each of the one or more of the plurality of power units comprises one or more of: a) an instruction to draw power from or supply power to the PDN; b) a time at which to start drawing or supplying power to the PDN; c) a time period for which to draw or supply power to the PDN,
wherein the first request comprises one or more of:
a) an amount of power to be supplied to or drawn from the PDN,
b) a response time within which the first request must be fulfilled, and
c) a frequency response request.

19-21. (canceled)

22. A method according to claim 17, wherein one or more of:
(a) the first parameter comprises one or more of:
(i) a measure of the inertia of the PDN;
(i) a measure of a frequency deadband of the PDN; and
(i) measure of a proportion of inertia contributing power generation systems supplying power to the PDN; and
(b) the control message sent to each of the one or more of the plurality of power units in the reserve state are sent at predetermined time intervals, the predetermined time intervals arranged to provide a shaped power response to the first request.

23. (canceled)

24. A method according to claim 17, wherein said power units are batteries or other energy storage devices,
wherein one or more batteries or other energy storage devices form part of one or more uninterruptable power supplies.

25. (canceled)

26. A method according to claim 17, further comprising one or more of:
(a) measuring the total power available from the plurality of power units in the reserve state, wherein said step of determining a proportion of power units to instruct to provide power to, or draw power from, the PDN is further based on the total power available,
(b) each power unit in the reserve state providing a status update including the power available from that unit, wherein the step of instructing one or more of the plurality of power units to provide power to, or draw power from, the PDN is further based on the power available in each unit, and
(c) monitoring a frequency of the PDN, wherein the step of determining a proportion of power units to instruct to provide power to, or draw power from, the PDN is further based on the frequency of the PDN and/or a rate of change of the frequency of the PDN.

27-28. (canceled)

29. A power distribution network (PDN), comprising:
a plurality of power units; and
a controller; wherein the controller is arranged to:
a) receive a first request to supply power to, or draw power from, the PDN;
b) receive a first parameter indicative of an inertia of the PDN;
c) determine, based on the first request and the inertia of the PDN, a proportion of the power units that are in a reserve state to instruct to provide power to, or draw power from, the PDN;
d) instruct, based on the determination, one or more of the plurality of power units in the reserve state to supply or draw power from the PDN in order that the determined proportion of the power units to instruct are instructed.

30-35. (canceled)
